(19) United States
(12) Patent Application Publication
(10) Pub. No.: US 2018/0032750 A1
(43) Pub. Date: Feb. 1, 2018

(54) INTEGRATED CREDENTIAL DATA MANAGEMENT TECHNIQUES

(71) Applicant: MorphoTrust USA, LLC, Billerica, MA (US)

(72) Inventor: Benjamin Hammel, Billerica, MA (US)

(21) Appl. No.: 15/665,037

(22) Filed: Jul. 31, 2017

Related U.S. Application Data
(60) Provisional application No. 62/368,935, filed on Jul. 29, 2016.

(51) Int. Cl. G06F 21/62; H04L 29/06; G06F 17/30

(52) U.S. Cl. CPC G06F 21/6218; G06F 17/30368; H04L 63/0853; H04L 63/083

(57) ABSTRACT

In general, systems and techniques are described for automating manual processes for managing credential data for customers have been issued a credential by an issuing authority. A system uses enterprise application software (EAS) with an integrated architecture that combines customer relationship management (CRM) software and commercial off-the-shelf (COTS) software. The integrated architecture is flexible such that credential data may be managed according to the standards and requirements of a particular issuing authorities such as government agencies and commercial organizations. The integrated architecture enables different enterprise applications to exchange credential data through a unitary identification management software that various types of credential data that are processed by an issuing authority. In this regard, end-users, such as customers, employees of the issuing authority, and third party entities, can use a single software platform to perform operations that are related to different business services.

### CROSS-REFERENCE TO RELATED APPLICATION

This application claims the benefit of U.S. Provisional Application No. 62/368,935, filed Jul. 29, 2016, and titled “INTEGRATED ELECTRONIC IDENTIFICATION MANAGEMENT SYSTEM AND ISSUANCE,” which is incorporated by reference in its entirety.

### FIELD

The present document generally relates to identification systems.

### BACKGROUND

Enterprise applications can often be used by issuing authorities such as government agencies to manage the submission, verification, and management of credential data associated with physical credentials. For example, a customer may submit credential data in order to obtain a driver's license issued by a state motor vehicle agency. The submitted credential data is then verified against other types of external information associated with the customer (e.g., social security number, place of residence, etc.). The verified credential data is then used to generate a database record that is associated with a database of the state motor vehicle agency.

Issuing authorities may also use enterprise application to generate digital identifications and digital identities for a user based on verified information that is included within a database record. For example, an enterprise application may be used to generate digital identifications associated with issued physical identification cards, and provisioned to electronic devices of the customer.

### SUMMARY

Enterprise applications are often used to improve data flow within complex application frameworks. For instance, enterprise applications can be used to consolidate data collection efforts and reduce data redundancies. However, a single enterprise application often lacks sufficient capabilities to effectively address the all of the specific requirements of issuing authorities that manage large volumes of secure credential data. For example, a single enterprise application is often unable to perform the various individual operations associated with customer credential issuance, e.g., verifying credential data for a new credential, issuing a physical identification based on the verified credential data, generating a digital identification and digital identity associated with the physical identification, monitoring transactions involving the issued physical identification, among others. In addition, these individual operations are often executed by different entities (e.g., the customer, the issuing authority, agencies related to the issuing authority, or a third party service provider associated with the issuing authority) with the use of data that is often stored in different server systems. This often introduces latency in performing complex operations that involve cross-verification of different types of credential data. In addition, because different enterprise applications may be used to perform these individual operations, many operations are often manually repeated for each of the different enterprise applications, potentially causing multiple instances of database records that often include redundant and/or outdated information. Likewise, changes to the data, records or applications may need to be made multiple times across multiple systems which is time-consuming and introduces the risk of errors with each change.

In general, one innovative aspect of the subject matter described in this specification can be embodied in systems that automate manual processes for managing customer credential data of enterprise application software (EAS) using an integrated architecture that combines customer relationship management (CRM) software, commercial off-the-shelf (COTS) software, and customized software for a particular issuing authority. The integrated architecture is flexible such that customer credential data may be managed according to the standards and requirements of the particular issuing authority, and accessed by third party service providers that are provide services associated with the particular issuing authority. For instance, the integrated architecture enables different enterprise applications to exchange credential data through a unitary identification management software that automatically processes various types of credential data required by an issuing authority. In this regard, end-users, such as customers, employees of the issuing authority, and third party entities, can use a single software platform to perform operations that are related to different business services (e.g., driver's services such as licensing and managing driver's privileges, vehicle services such as registrations and inventory management, and business licensing services etc.).

The system includes an identification repository that stores information for customers that have issued an identification by the issuing authority within a database record. The database record includes various types of information that are associated with different services used by the customer (e.g., driver's license issuance, vehicle registration, business licensing, etc.). In this regard, the identification repository aggregates and accumulates various types of credential data that are used by different components of the system into a single record for simplified access and modification. The database record may also specify relationships between different types of credential data (e.g., associating a driver's license ID with a vehicle registration), or relationships between different customers (e.g., customers that share the same vehicle service company). In this regard, credential data stored within the identification repository may be used to provide comprehensive real-time reporting capabilities for both customers and other users that have authorized access to the credential data (e.g., an employee of the issuing authority, an authorized third party business party of the issuing authority).

The system also includes various software modules that are used to support different types of users associated with an issuing authority. For example, the system may include a customer portal that enables a customer to register for a new physical identification, update an existing database record associated with a physical identification, or enroll into a program to obtain a digital identification and/or a digital identity that is associated with verified credential data stored in the database record. In another example, the system may include a record management module that provides an administrator (e.g., an analyst of the issuing authority) with real-time access to credential data stored within the identification repository. This access can be used to quickly and accurately verify customer credential data and/or transactions that are determined to be associated with the customer credential data. In yet another example, the system may provide third party users that have business relationships with the issuing agency (e.g., government contractor) with secure access to credential data stored within the identification repository in order to support operations that rely upon the credential data, e.g., vehicle services, driver license services, driver enforcement services, business licensing services, financial operations, document imaging, among others.

The system architecture enables the system to be configured according to the usage requirements and standards for a particular issuing authority. For instance, the system incorporates both COTS software components and CRM, and customized software components that are specifically designed for the particular issuing authority. The adjustment of such components may be modularized with the use of individual configuration rules such that a change to one component does not impact the configuration of another component. For instance, the system architecture may utilize a rule engine that applies both general configuration rules and organization-specific configuration rules to customize individual modules incrementally while also retaining enterprise capabilities of the COTS software components. In this regard, individual configuration rules that impact specific components may be added to the rule engine to change the configuration of individual components without requiring changed to software.

In one general aspect, a method includes the operations of: obtaining, by a server system, credential data for a customer, the credential data indicating a credential issued to the customer by an issuing authority; obtaining, by the server system and from one or more external computer systems that are distinct from the server system, verification data associated with the credential issued to the customer; processing, by the server system and based at least on the verification data obtained from the one or more external computer systems, contents of one or more database fields within a database record associated with the customer; updating, by the server system, the database record for the customer based on processing the contents of one or more database fields; and providing, by the server system and to one or more third-party computer systems over an external interface gateway, access to at least a portion of the updated database record.

One or more implementations can include the following optional features. For example, in some implementations, the obtained credential data for the customer includes user-specified values for the one or more database fields. In such implementations, processing the contents of one or more database fields includes: identifying one or more verified values of the one or more database fields within the verification data obtained from the one or more external computer systems; and determining that the user-specified values for the one or more database fields are valid based on comparing the user-specified values for the one or more database fields to the one or more verified values of the one or more database fields within the verification data.

In some implementations, the database record is stored in an identification repository, and the identification repository includes database records associated with different customers. In such implementations, processing the contents of one or more database fields includes: determining, based on the verification data obtained from the one or more external computer systems, that a particular database record from among the database records within the identification repository is associated with the customer; generating a mapping that associates one or more fields of the database record and one or more corresponding fields of the particular database that is determined to be associated with customer; and updating the database record for the customer includes storing the generated mapping within the database record.

In some implementations, the server system is managed by an entity that is distinct from each of (i) the issuing authority, (ii) entities that manage the one or more external computer systems, and (ii) entities that manage the one or more third-party computer systems.

In some implementations, the one or more external computer systems include a legacy computer system of the issuing authority. In such implementations, the method further includes the operations of: identifying, by the server system, a change to a legacy database field within a legacy database record that is (i) associated with the customer, and (ii) stored at the legacy computer system; and generating, by the server system and based on the identified change to the legacy database field within the legacy database record, a first instruction to update a database field within the database record, the database field within the database record corresponding to the legacy database field within the legacy database record.

In some implementations, the method further includes the operations of: identifying, by the server system, a change to a second database field within the database record; and generating, by the server system and based on the identified change to the second database field within the database record, a second instruction that, when received by the legacy computer system, causes the legacy computer system to update a second legacy database field within the legacy database record, the second database field within the database record corresponding to the second legacy database field within the second legacy database record.

In some implementations, the one or more external computer systems include a computer system managed by an entity that is distinct from the issuing authority.

In some implementations, the one or more external computer systems includes (i) a first computer system running COTS software, and (ii) a second computer system running CRM software. In such implementations, the server system includes a communication module that exchanges data transmissions with each of the COTS software and the CRM software.

In some implementations, the credential issued to the customer is a physical credential.

In some implementations, the credential issued to the customer is a digital credential.

In some implementations, the method further includes the operations of: obtaining, by the server system and from a rule repository, data indicating multiple configuration rules for computing a data parameter associated with the credential issued to the customer; selecting, by the server system, a configuration rule from among the multiple configuration rules based on the verification data obtained from the one or more external computer systems; and computing, by the server system, the data parameter associated with the credential issued to the customer based on the selected configuration rule.

In some implementations, the multiple configuration rules include (i) a first configuration rule specifying a first computation of the data parameter based on a first definition, and (ii) a second configuration rule specifying a second computation of the data parameter based on a second definition, the first definition being different than the second definition; and the verification data obtained from the one or more external computer systems indicates that a jurisdiction associated with the credential will introduce legislation that adjusts the first definition to the second definition at a specified date. In such implementations, the method further includes the operations of: before the specified date, computing, by the server system, the data parameter associated with the customer based on the first configuration rule; and after the specified date, computing, by the server system, the data parameter associated with the customer based on the second configuration rule.

The techniques described within this document may provide one or more of the following technical advantages. Other advantages are discussed throughout the detailed description. The present technology improves data retrieval, synchronization, aggregation, and/or replication between disparate computer systems that are typically unable to exchange data communications using, for example, EAS, CRM, and COTS software. For example, the technology described in this document allows an issuing authority that has implemented a modernized credential issuance system to maintain data communications with legacy computer systems that store existing credential data. Such data communications can be used to maintain, for example, data dependencies between the modernized system and the legacy systems to reduce the likelihood of replication errors, data redundancies, and/or other types of technical implementation issues. As another example, some implementations of the technology described in this document enables bi-directional data synchronization between a modernized identification management system and a legacy system, which allows an issuing authority to maintain distinct identification repositories associated with each system without requiring manual data updates and/or large-scale data replication efforts. To accomplish this, the technology provides, for example, a change-based data synchronization feature where detected changes in an identification repository of either the modernized system or the legacy system results in a periodic data replication and synchronization operations. The change-based data synchronization feature may be used to reduce the likelihood of synchronization or replication errors when maintaining credential data associated with both modernized systems and the legacy systems.

The present technology also improves resource allocation and, for example, the speed by which data associated with a credential issued to a customer is retrieved from an identification repository. As discussed below, an identification management system provides an integrated architecture that allows the system to retrieve verification data from one or more external computing systems of service providers that are associated with the issuing authority that issues the credential. The system can then process credential data stored in the identification repository in relation to the retrieved verification data to identify multiple database records within the identification repository that are associated with the same customer and/or issued credential. For example, the processing technique can be used to associate a database record for a customer's driver license, and a database record for a vehicle registration for a vehicle primarily used by customer. In this example, the technology enables the system to associate database records that may have been otherwise unable to be associated without the obtaining external verification data to identify privileges associated with the credential issued to the customer.

Additionally, the present technology enables a system to perform functions that are not previously capable of being performed by other identification management systems that do not use an integrated architecture for data transmissions. For example, the system described herein can manage updates and/or changes to data for an issued credential, e.g., a name change submitted by a customer, issuance of a new physical credential provided by the issuing authority, etc. The system can then use the integrated architecture to perform various types of data synchronization operations such that other external systems that also store data for issued credential do not store outdated credential data. In this manner, the system is capable of harmonizing credential data stored on multiple different computer systems are often managed by the issuing authority.

Other implementations of these aspects include corresponding systems, apparatus and computer programs, configured to perform the actions of the methods, encoded on computer storage devices.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1A illustrates an example of an identification management system/

FIG. 1B illustrates examples of different users that may use the identification management system.

FIGS. 2A-2B illustrate examples of software modules that may be used by a customer.

FIGS. 3A-3B illustrate examples of software modules that may be used by an administrator.

FIG. 4 illustrates an example of a rule engine for configuring and customizing individual software modules of the identification management system.

FIG. 5 is a schematic diagram that illustrates an example of a process for adjusting the management of credential data based on changes to legislative frameworks relating to a credential issued to a customer.

FIG. 6 is a schematic diagram that illustrates an example of an architecture that enables bi-directional data synchronization between two identification systems of an issuing authority.

FIG. 7 is a flowchart that illustrates an example of a process for managing credential data for a customer using an integrated architecture.

FIG. 8 is a block diagram of computing devices on which the processes described herein, or portions thereof, may be implemented.

In the drawings, like reference numbers represent corresponding parts throughout.

### DETAILED DESCRIPTION

In general, this document describes systems and techniques that automate manual processes for managing credential data for customers have been issued a credential by an issuing authority. In some implementations, a system uses enterprise application software (EAS) with an integrated architecture that combines customer relationship management (CRM) software and commercial off-the-shelf (COTS) software. The integrated architecture is flexible such that credential data may be managed according to the standards and requirements of a particular issuing authorities such as government agencies and commercial organizations. The integrated architecture enables different enterprise applications to exchange credential data through a unitary identification management software that various types of credential data that are processed by an issuing authority. In this regard, end-users, such as customers, employees of the issuing authority, and third party entities, can use a single software platform to perform operations that are related to different business services (e.g., driver's licenses services, vehicle registration services, etc.).

As described herein, a “customer” refers to an individual or an organization that receives services from an issuing authority. For instance, a customer may obtain a physical identification, e.g., a driver license, a state identification card, that is issued by the issuing authority. The customer may also obtain licenses and/or permits that are associated with the physical identifications, e.g., a vehicle registration, professional license, trade license or a firearm permit. The customer may submit credential data such as enrollment data for applying for a credential, which is then processed, verified and stored as a database record within an identification repository associated with the issuing authority. Information stored within the database record may be easily accessed for various operations that are performed by the issuing authority and third party service providers that are authorized provide business services using the credential data.

An “administrator” refers to an employee of the issuing authority that performs various operations of the issuing authority using customer data stored within the database record. For instance, an administrator may perform various search functions to quickly identify information that is relevant to a verification operation. In another instance, the administrator may also process updates to credential data and/or provide software upgrades to individual modules that operate within the system. An example of an administrator may be an analyst or an examiner of a state motor vehicle agency.

A “third party user” refers to an individual associated with a third party service provider, e.g., financial institutions, local government agencies, or commercial entities, that utilize information stored within the database record to provide various business services to the customer. For instance, the third party organizations may obtain data indicating processed transactions associated with customer credential data included within the database record in order.

A “legacy system” refers to any computer system that implement existing methods, programs, or technology that may be rendered obsolete due to modernization and development. A legacy system of an issuing authority can refer to a computing system that stores existing data relating to credentials issued to customers by the issuing authority when the issuing authority implements changes to, for instance, technological protocols and/or the process that are used to issue subsequent credentials. As an example, once an issuing authority that implements a new issuance process that utilizes modernized software protocols, legacy systems can represent computer systems that implement prior software protocols associated with the prior issuance process. In this regard, any computing system associated with an issuing authority can become a legacy computer system after a certain period of time once the issuing authority adopts and/or implements new protocols and/or processes for issuing or managing customer credentials.

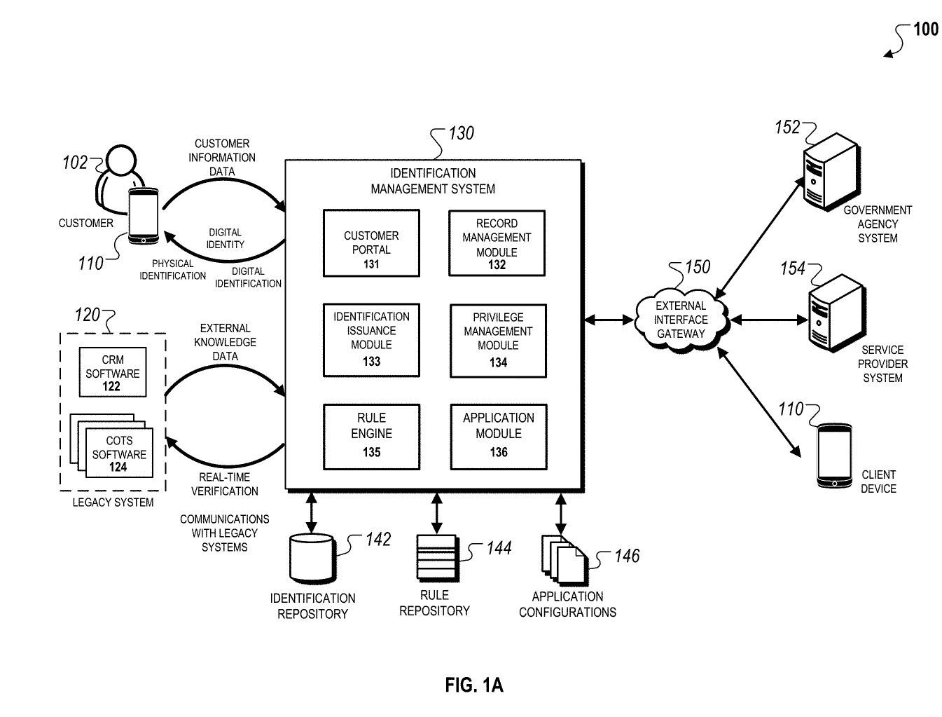

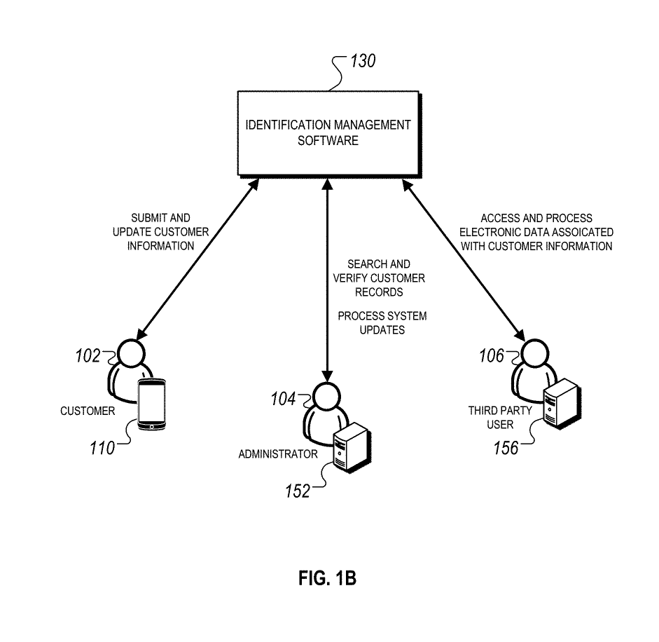

FIG. 1A illustrates an example of a system 100. The system 100 generally includes a customer device 110, external systems 120, identification management system (IMS) 130, and external devices such as a government agency system 152, and/or a service provider system 154 connected to IMS 130 over an external interface gateway 150. The external systems 120 further include CRM software 122 and COTS software 124. The IMS 130 further includes a customer portal 131, a record management module 132, an identification issuance module 133, a privilege management module 134, a rule engine 135, and an application module 136. The IMS 130 further stores an identification repository 142, a rule repository 144, and application configurations 146, which are accessed by different components of the IMS 130.

In general, the system 100 may be used to perform various operations associated with an issuing authority. Although the issuing authority may be any type of government agency or commercial entity that provides customers with access and manage their secure credential data, maintains the secure credential data within an identification repository, and provides authorized access to the credential data to commercial partners, the descriptions throughout this document refer specifically to state departments of motor vehicles for clarity and simplicity.

In some implementations various types of credentials can be issued and/or managed by the system 100 using the techniques described throughout this document. In one example, the system 100 can manage healthcare-related credentials that are issued to customers such as health insurance cards. In this example, the system 100 can manage various types of transaction data relating to submitting healthcare reimbursement claims, processing transactions relating to annual deductibles for a health insurance plan, among others. In another example, the system 100 can manage credentials relating to a 401(k) retirement plan. In this example, the system 100 can process transactions relating to contributions, such as employer contributions and individual contributions, among others. In yet another example, the system 100 can process transactions various types of state-issued identifications such as passports, green cards, and others. In this example, the system 100 can process transactions related to international travel, immigration applications. The management of other types of credentials, and privileges associated with those credentials, are contemplated using the techniques described throughout this document.

As depicted in FIG. 1A, the system 100 may include various devices and/or components that are associated with different entities in order to perform different operations associated with the issuing authority. Although operations may be performed by different users as noted above, and using different systems, the IMS 130 may be used to coordinate the different processes in order to ensure that credential data associated with a particular customer 102 and obtained from different data sources and users, are all stored within a single database record corresponding to the customer 102 within the identification repository 142. Examples of different processes managed by the IMS 130 are discussed below.

In one management process, the IMS 130 may be used by a customer 102 to submit enrollment data (e.g., proof of identity) on the customer device 110 during a registration process to obtain a new identification and/or credential that is issued by the issuing authority. The customer device 110 may be any type of personal electronic computing device that has access to the IMS 130. For example, as described below, access to the IMS 130 may be provided through a webpage-based user interface through any suitable internet browser, through a mobile application that is executed on the customer device 110. In some implementations, as noted below, instead of using the customer device 110 to provide credential data data, the customer 102 may instead use a dedicated kiosk that is provided by the issuing authority at a predetermined location.

The submitted credential data data may then be processed, verified, and stored within the identification repository 142. If the customer 102 is a customer that does not have an existing credential issued by the issuing authority, then a new database record is then generated for the customer 102 and stored within the identification repository. Alternatively, if the customer 102 is an existing customer that instead is applying for a new credential, then the submitted credential data data may be added to the existing database record for the customer 102 within the identification repository 142. Once the submitted credential data data has been processed and verified, the issuing authority provides the customer 102 with one or more generated credentials that are associated with a particular service offered by the issuing authority.

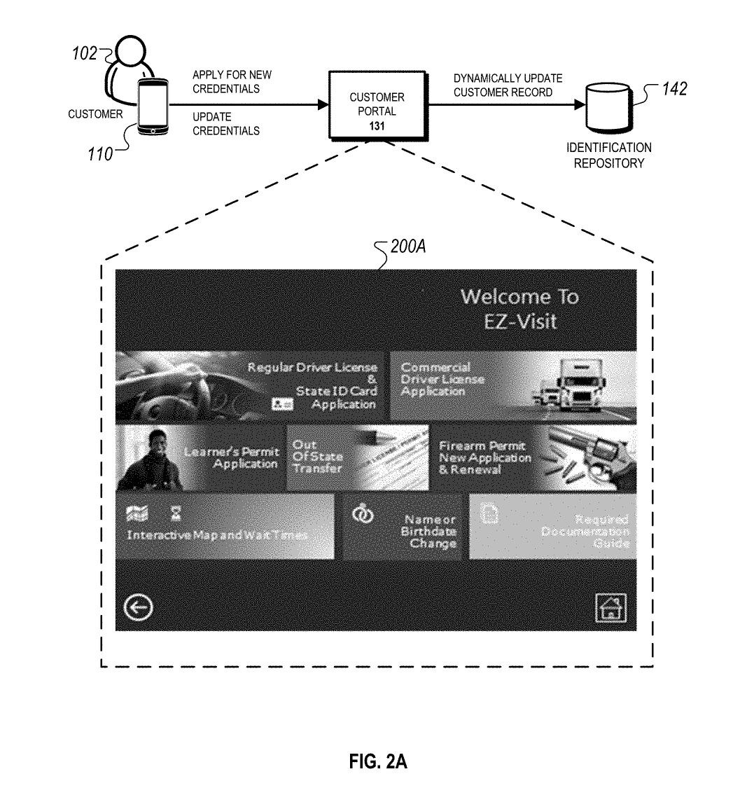

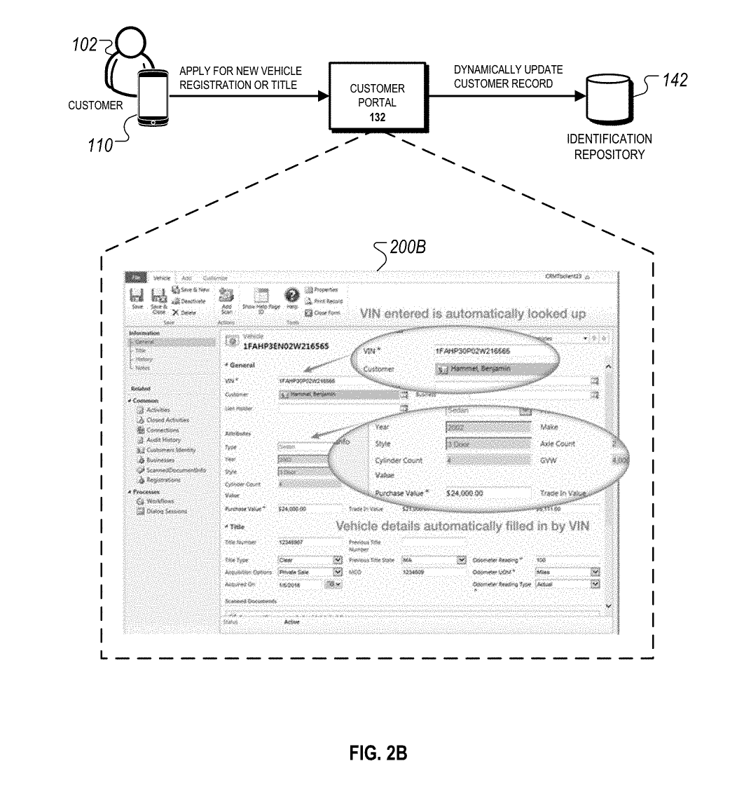

In the example depicted in FIG. 1A, the customer 102 may receive either a physical or digital identification that includes the verified credential data and includes a unique identification number (e.g., driver license ID), or a digital identity that may then be used to authenticate the user on other web services that are provided by the issuing authority (e.g., a customer profile that is accessed using a username and password). More particular examples of operations performed by the customer 102 are described below with respect to FIGS. 2A-2B.

In another management process, the IMS 130 may be used to exchange data with legacy system 120 that are either associated with the same issuing authority, or associated with a different issuing authority and/or organization that also manages credential data associated with the customer 102.

The legacy system 120 may represent software that is either associated with the same issuing authority as the IMS 120, or a different issuing authority that also manages information associated with the customer 102. The CRM software 122 may represent a credential data data model that tracks relationships between the information included in different database records within the identification repository 142. As an example, if the customer 102 is an individual, the CRM software 122 may be used to associate issued driver licenses, registered vehicles, and mailing addresses associated with the customer 102 within a single database record. Alternatively, if the customer is a commercial entity such as a car dealership, the CRM software 122 may be used to associate corporate information (e.g., primary corporate address, employees, etc.) with franchise-specific information (e.g., dealership primary addresses, vehicles associated with a particular franchise, etc.).

The COTS software 124 may represent various types of commercially available software that may be used by the issuing authority associated with the IMS 130, or other issuing authorities that also manages information associated with the customer 102. Examples of the COTS software 124 may include, for example, software that includes an address lookup engine, an external business rules engine, network, network and endpoint monitoring and analytics, point of sale (POS) services, accounts payable/receivable services, inventory management, system monitoring and management, document sharing and display, data analytics and reporting, among other types of functions.

In the example process depicted in FIG. 1A, the IMS 130 may obtain external knowledge data from the legacy system 120 that is associated with the credential data data and/or credential data that is included within the database record stored in the identification repository 142. For instance, during a verification operation, where the IMS 130 attempts to verify that an existing identity of the customer 102 matches that claimed identity within the credential data data, the IMS 130 may obtain other types of data associated with the customer 102 (e.g., social security data, residence information) from the legacy system 120.

In some implementations, the legacy system 120 may include pre-existing software frameworks that are used by the issuing authority to perform ancillary operations that are related to the credential data within the database record stored on the identification repository 142. In such implementations, the IMS 130 may be configured such that the IMS 130 is able to obtain credential data associated with the legacy system 120 to store within the identification repository without requiring substantial software upgrades and/or modifications to the legacy system 120. In this regard, the IMS 130 may be configured to enable data exchanges with legacy systems that were previously implemented within the issuing authority's software architecture, while also consolidating the previously generated credential data into a single database record that is stored within the identification repository 142.

In yet another management process, the IMS 130 may provide access electronic data associated with the database record to different authorized systems over the external interface gateway (EIG) 150. The EIG may represent a service-orientated architecture that is configured to provide electronic data that is associated with credential data stored within the identification repository 142. For example, the electronic data may include financial transactions made by the customer 102 that are identified using the credential data stored within the database record for the customer 102.

The electronic data may also include verified credential data that can then be used by third party organizations to perform shared general services. Examples of shared general services include correspondence management (e.g., creating a dynamically generated notification if a customer is suspended based on violations or citations attached to his/her record), case management (e.g., identifying suspected fraud, medical review, or refunds associated with a database record), or scanning procedures (e.g., obtaining scanner copies of a customer's physical identification that is stored within the database record). Other examples include auditing and logging (e.g., reporting all transactions and user actions that are mapped to physical locations and network locations with date and time stamps), or ad hoc reporting and queries (e.g., providing access to credential data stored within the identification repository 142), and/or data warehouses (e.g., tracking and monitoring of key business intelligence and performance indicators that are provided to third party organizations).

The EIG 150 enables the IMS 130 to exchange electronic communications with various external systems such as the government agency system 152, and/or the service provider system 154 over a secure network to ensure a compliant transaction. Access to electronic date over the EIG 150 may be provided over various access channels. For instance, in one example, access to the electronic data may be provided through a webpage-based web interface that may be accessed from either a desktop computing devices (e.g., workstations and personal desktop computers) and/or a mobile computing devices (e.g., smartphones, tablets, smart wearable devices, etc.). In another example, access may be provided through a self-service kiosk that is situated in designated locations by the issuing authority (e.g., a kiosk placed within a state department of motor vehicle office). In yet another example, access may also be provided on designated workstations that are located in a central office associated with the IMS 130. Other access mechanisms such as email or telephone using Interactive Voice Response (IVR) may also be used.

In addition, access privileges to the credential data stored within the identification repository 142 may be adjusted based on the entity associated with the particular system that requests access over the EIG 150. For instance, a government agency may have unrestricted access to view all types of credential data that is stored within the identification repository 142, whereas a vehicle service provider may only have limited access to view vehicle-related information within the stored credential data. In other instances, access to credential data may be restricted to specific database records instead of the types of credential data. For example, a service provider that only services a population of customers within a particular geographic location may only have access to database records for the customers that are identified to be located within the particular geographic location. In another example, a customer that accesses the identification repository 142 may only have access to his/her database record only and not to other database records associated with other customers.

The government agency system 152 may be any electronic computing device that is either associated with a government entity. For instance, in some implementations where the IMS 130 is operated and management by a data service provider, the system 152 may refer to computing devices that are associated with the issuing authority that regulates the credential data stored within the identification repository 142. In such implementations, employees and/or individuals that are affiliated with the issuing agency may access the credential data stored within the identification repository 142 through the EIG 150. In other implementations, the government agency system 152 may instead refer to computing devices that are instead associated with different government agencies that instead are allowed and/or authorized by the issuing authority to access the credential data stored within the identification repository 142. For example, in such implementations, the government agency system 152 may refer to computing devices that are associated with a federal government agency that has access to the credential data stored within the identification repository 142.

The service provider system 154 may refer to any electronic computing device that is associated with a third party service provider that is authorized by the issuing authority to access credential data stored within the identification repository 142. As described above, the service provider system 154 may be associated with various third party organizations that have existing business relationships with the issuing authority. For example, the third party organizations may include the Problem Driver Point System (PDPS), Commercial Driver's License Information System (CDLIS), Social Security Online Verification (SSOLV), National Motor Vehicle Title Information System (NMVTIS), or National Crime Information System (NCIC).

As described above, the customer device 110 may refer to any personal electronic computing device that may be used by the customer 102 to access credential data stored in the identification repository 142. For example, the customer 102 may access credential data through the EIG 150 in order to register for a new identification, update information associated with an existing identification, and/or update demographic information associated with a database record (e.g., updated mailing address).

Referring now to the components of the IMS 130, the IMS 130 may include various modules that are configured to perform specific operations related to the processing, verification, and/or management of credential data. The IMS 130 also access a set of stored data (e.g., the identification repository 142, the rule repository 144, and the application configurations 146), which are used to support the operations performed by the component modules of the IMS 130. The functions of each component module, and how they relate to the stored data, are described in detail below.

The customer portal 131 refers to a software module that assists the customer 102 to submit new credential data and/or modify existing credential data related to a database record corresponding to the customer 102. As an example, the customer 102 may use the customer portal 131 to apply for a new credential such as a driver license, or change an existing credential (e.g., upgrading or downgrading, making changes to name, date of birth, gender, customer demographics, etc.)

The customer portal 131 may present various user interfaces that provides the customer 102 with a series of questions to determine what documents, fees, or information they will need to bring to the issuing agency office based on the transaction that the user 102 is looking to complete (e.g., applying for a new identification). In some instances, the customer 102 may be able to complete the transaction entirely on the customer portal 131, whereas in other instances, the customer 102 may initiate the transaction on the customer portal 131 and then schedule a physical appointment at an office that is associated with the issuing authority (e.g., to submit fingerprints required for a particular transaction). As noted above, the customer portal 131 may either be accessed through a webpage that is associated with the IMS 130, a mobile application that is executed on the customer device 110 and configured to exchange communications with the IMS 130, or on a designated kiosk located in an office associated with the issuing authority. Specific examples of user interfaces provided on the customer portal 131 are depicted in FIGS. 2A-2B.

The record management module 132 enables the customer 102, the administrator (e.g., an employee or individual of the issuing authority or an authorized data service provider of the issuing authority), or the third party user (e.g., a system administrator of a third service party service provider authorized by the issuing authority to access database records) to process database records within the identification repository 142. For example, the record management module 132 may be used to perform searches for credentials and/or credential data against the identification repository 142, create a database record using a captured information from a kiosk (e.g., photo, signature, completed text fields), perform identity verification checks to validate information submitted on external systems (e.g., credential data received on a third party system to be verified against credential data stored within the identification repository 142), and/or associated related information to existing database records (e.g., adding or updating a vehicle registration that is associated with a driver license included within a database record). In addition, the record management module 132 enables dynamic filtering of database records by specified search criteria (e.g., identifying database records associated with specific citations and/or violations within a particular period of time). The record management module 132 may additionally be used to merge duplicate database records for a single customer and/or consolidate different sources of credential data into a single database record.

The identification issuance module 133 and processes a transaction that includes credential data received on the customer portal 131, and initiates a set of verification operations along with the privilege management module 134 in order to generate and issue an identification that is associated with the transaction. For example, in response to the customer 102 may submit an application for a new driver license on the customer portal 131, the submitted credential data may then be verified using external customer data from other issuing authority systems. In response to determining that the submitted credential data is in fact valid and verified, the identification issuance module 133 may generate the driver license for the customer 102. The identification issuance module 133 then creates a new driver license ID, associates the newly created driver license ID with the database record associated with the customer 102, and then sends an instruction to a printing facility associated with the issuing authority to issue and mail a new physical identification. In this regard, the identification issuance module 133 tracks and records key milestones associated with the issuance of a physical identification that can then be accessed by the administrator when viewing the database record on the record management module 132.

The privilege management module 134 performs determines whether there have been any negative actions taken against the customer 102 during a verification operation of the submitted credential data. For example, the privilege management module 134 may analyze correspondence data within the database record to identify any sanctions that have been placed against the customer 102 (e.g., fines for driving violations), or changes to the current status of existing identifications associated with the customer 102 (e.g., suspended license). The privilege management module 134 also analyze historical information such as prior suspensions and/or reinstatements, prior fines and violations, or any citations that have been included in the database record.

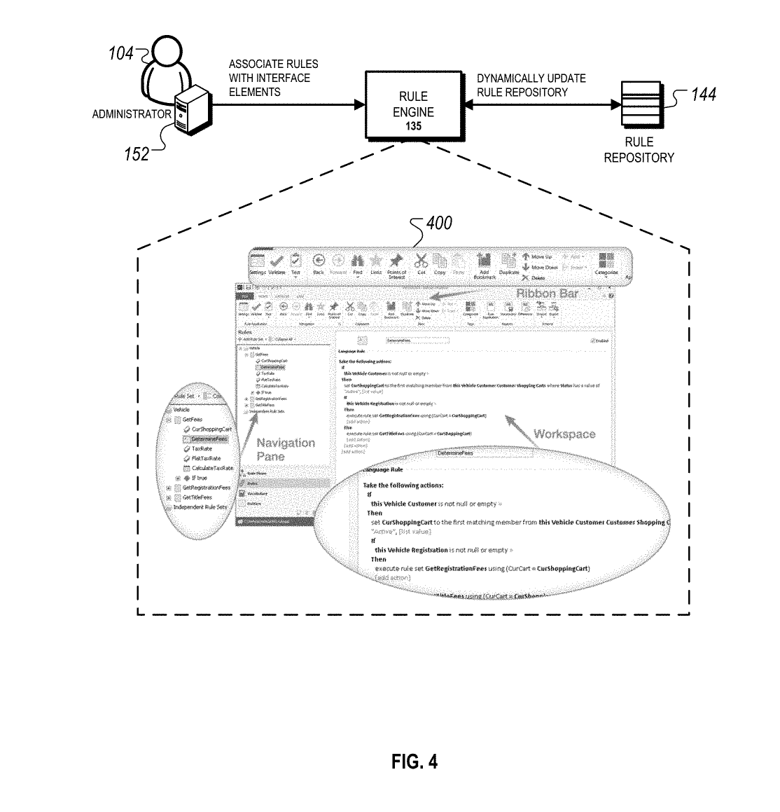

The rule engine 135 enables the IMS 130 to execute business workflows associated with operations that are performed by various components with the use of individual rules that are designed to satisfy business requirements. For instance, individual rules may be stored within the rule repository 144 and executed when a trigger associated with a particular rule has been satisfied. In addition, the rule repository 144 may be dynamically generated such that new rules can be defined and added to the rule repository 144 by the administrator based on the changing business requirements and objectives of the issuing authority. For example, individual rules may be associated with user interface elements that are provided on either the customer portal 131 or the record management module 132 to calculate variable parameters such as vehicle registration fees. More particular descriptions related to interfaces provided by the rules engine was described below with respect to FIG. 4.

The application module 136 enables the IMS 130 to configure and/or reconfigure applications that are provided for output to customers, administrators, and third party users. For instance, the application module 136 may use the application configuration 146 to provide user interfaces that allow users to perform operations described throughout. The application configurations may include executable computer-readable instructions that allow the application module 136 to provide a particular application for output, or configuration information that support the execution of the particular application (e.g., style specification sheets). In this regard, the application module 136 may use the application configurations 146 to dynamically update the functionality of existing applications, and/or generate new applications that are provided for output to users.

The application module 136 may provide different applications for out to customers, administrators, and third party users. As an example, the application module 136 may provide a database record management application to customers only to enable the viewing, tracking, and monitoring of credential data stored within the identification repository. Another example of an application module 136 provided to customers is a vehicle management application that enables a user to provide vehicle registration information (e.g., a VIN number) and include information about prior and ongoing maintenance. The data associated with the database record management application and the vehicle management application may then be processed as data relationships (e.g., a driver license associated and a registered VIN associated with the same driver license ID) and stored within the database record. In another example, the application module 134 may provide a different database record management application to administrators and/or third party users that is not focused on adding/updating credential data but on performing verification operations on multiple database records and reviewing customer correspondence data for potential sanctions, citations, and violations. In these examples, the application module 136 may configure a baseline user interface for a database record management application and configure the options available to the user using different application configurations 146 for the customer, the administrator, and the third party user.

FIG. 1B illustrates examples of different users that may use the IMS 130 to perform different operations. For instance, as described above, the customer 102 may view, submit and/or update credential data included within the database record stored on the IMS 130 using the customer device 110. FIGS. 2A-2B illustrate examples of specific software that may be used by the customer 102 to access a specific database record stored on the IMS 130.

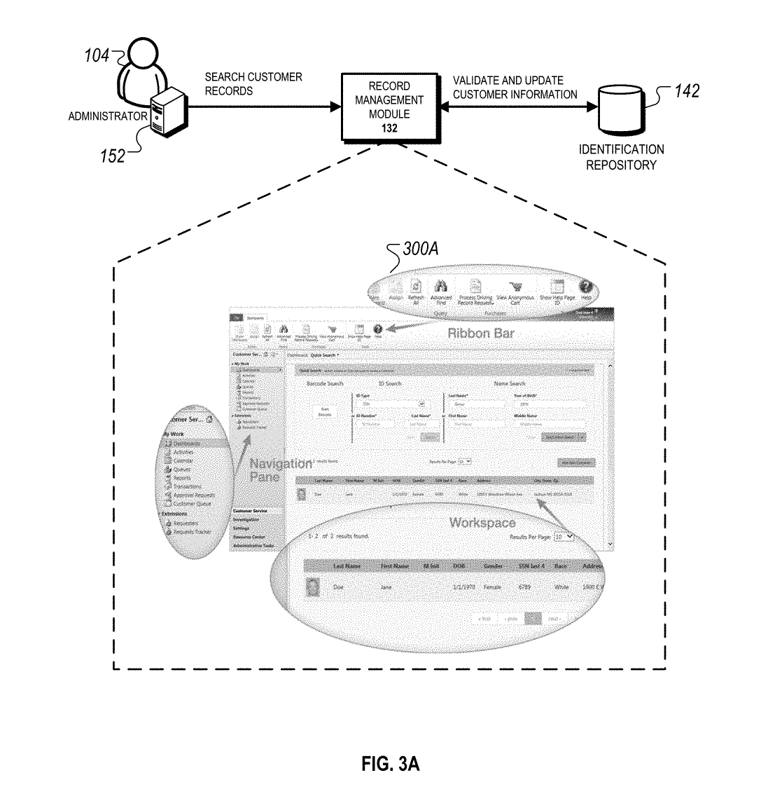

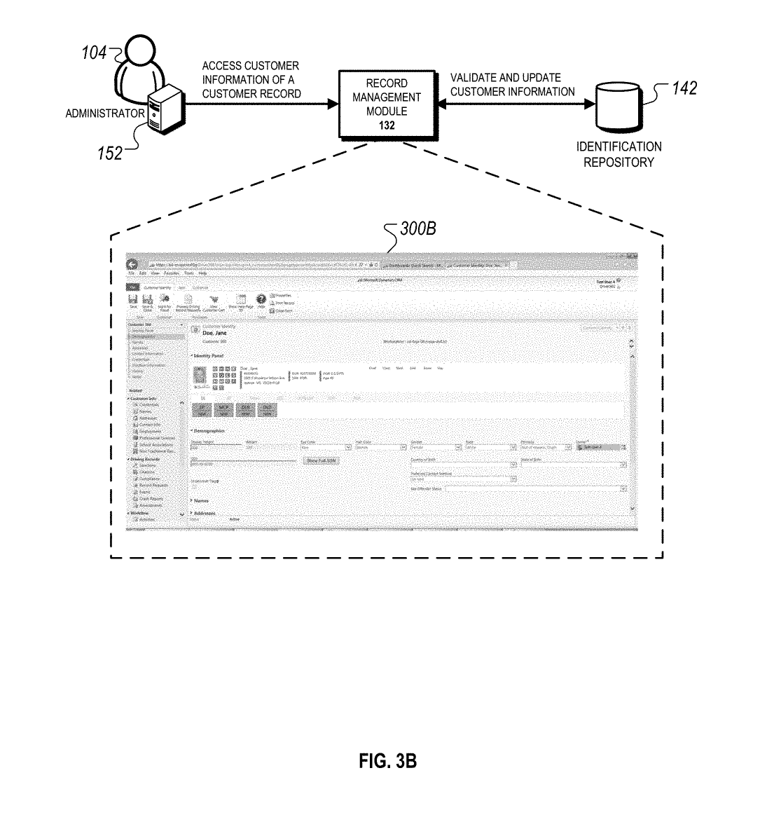

In addition, an administrator 104 may search and verify the credential data included within the database record using a device that is associated with the government agency system 152. As an example, the administrator 104 may perform searches for credential data to identify database records within the identification repository 142 that are responsive to a set of submitted search criteria. In other instances, the administrator 104 may perform verification operations against the information included within a database record to determine if an external data source includes verified credential data. FIGS. 3A-3B illustrate examples of specific software that may be used by the administrator 104 to access different database records stored on the IMS 130.

In some implementations, in addition to searching and verifying database records stored within the identification repository 142, the administrator 104 may also initial system updates that reconfigure the functionality of the IMS 130 to updated requirements and/or objectives of the issuing authority. For example, as described more particularly with respect to FIG. 4, in such implementations, the administrator 104 may add a new and/or adjust the specifications for existing rules within the rule repository 144 in order to adjust the functionality of individual software modules of the IMS 130. The system updates may then be implemented by using the rule engine 135 to execute the new or updated rules within the rule repository 144. The adjustments to the IMS 130 may be changes to application logic of the IMS 130 (e.g., including additional legacy system 120 that interfaces with the identification 130, or adding new systems to exchange data communications with over the EIG 150), or changes to the business workflows to reflect changes in business logic (e.g., adjusting rules for calculating business variables that are provided for display on user interfaces).

A third party user 106 may access electronic data associated with database records as noted above. The third party user 106 may use the accessed electronic data to provide general services associated with the credential data. Such services can include correspondence management (e.g., creating a dynamically generated notification if a customer is suspended based on violations or citations attached to his/her record), case management (e.g., identifying suspected fraud, medical review, or refunds associated with a database record), or scanning procedures (e.g., obtaining scanner copies of a customer's physical identification that is stored within the database record). Other examples include auditing and logging (e.g., reporting all transactions and user actions that are mapped to physical locations and network locations with date and time stamps), or ad hoc reporting and queries (e.g., providing access to credential data stored within the identification repository 142), and/or data warehouses (e.g., tracking and monitoring of key business intelligence and performance indicators that are provided to third party organizations).

FIGS. 2A-B illustrate examples of software modules that may be used by a customer. Referring initially to FIG. 2A, the customer 102 may use an interface 200A provided on the customer portal 132 to apply for a new credential that is issued by an issuing authority (e.g., apply for a state identification card), or update customer credential information for an existing credential that has already been issued to the customer (e.g., an existing stated issued driver's license). The input provided on the interface 200A is then processed by the customer portal 131 and processed in real-time to dynamically update the database record stored within the identification repository 142. For example, if the customer 102 changes the demographic information associated with the database record, the input provided on the interface 200A may then be process to reflect updates to the database record stored on the identification repository 142.

Referring now to FIG. 2B, the customer 102 may use an interface 200B provided on the customer portal 132 to add or update vehicle information associated with a database record. In this example, the customer 102 may use the interface 200B to apply for a new vehicle registration or title using a pre-established database record stored within the identification repository 142. In addition, the administrator 104 and the third party user 106 may also use the interface 200B to search for database records online and initiate such transactions on the customer's behalf.

After accessing the database record associated with the customer 102, the customer 102 may then submit vehicle information into a data entry field. For example, as depicted, the customer 102 may submit a vehicle ID number (VIN) associated with the vehicle, which is then automatically access vehicle data may be obtained using a VIN look-up service. As depicted, vehicle details associated with the submitted VIN are automatically populated in text fields to automate the vehicle information submission process. Once the customer 102 submits the transaction on the customer portal 132, the obtained vehicle information associated with the submitted VIN can then be stored within the database record in the identification repository 142. In this regard, after the database record has been updated, a customer identifier associated with the database record can then be related to a VIN of a vehicle that is associated with the same database record.

FIGS. 3A-B illustrate examples of software modules that may be used by the administrator 104. Referring initially to FIG. 3A, the administrator 104 may use an interface 300A search for database records of interest within the identification repository 142. As depicted, the interface 300A includes a ribbon bar to perform certain tasks such as an advanced find and/or process driving record request for a particular customer. The interface 300A also includes a navigation pane that enables the administrator 104 to access different types of data associated with either a particular database record, or a collection of database records. For example, the navigation pane may be used to access dashboards that represent high-level overviews associated with database records, view recent activity associated with a particular database record, and/or save the accessed information as a report to be exported and saved for later access. In addition, the interface 300A also includes a workspace area that displays data and/or information related to the selection made by the administrator 104 on the navigation pane.

The administrator 104 may use the interface 300A to perform a quick search of database records according a set of search criteria and view a list of database records that are provided in response to the quick search. For example, as depicted, the administrator 104 may search by information associated with a customer identifier such as a barcode scan of a physical identification of the customer, identification type (e.g., SSN), or identification number, or by demographic information associated with the customer such as last name, first name, date of birth, or a combination of both. In response to the submitted search query, the administrator 104 then receives a list of database records that are determined to be matches for the search criteria of the submitted search query. The administrator 104 may then view the database record, update credential data included in the database record, and/or add other information to be included in the database record.

Referring now to FIG. 3B, the administrator 104 may use an interface 300B on the record management module 132 to verify customer credentials that are associated with an existing database record. As depicted, the interface 300B includes a navigational pane to the left that enables the administrator 104 through different categories of credential data included within the database record (e.g., identity panel, demographics, names, addresses, contact information, credentials, violation information, history, notes). The interface 300B organizes the different types of credential data to the right of the navigational pane.

As depicted, the identity panel provides credential data that is often included within a physical identification (e.g., blood type, organ donor status, address, SSN, date of birth, age, etc.). The identity panel also identifies different identifications that have been issued to the customer by the issuing authority, and statuses associated with the each of the different identifications. The demographics tab represents demographic information associated with the customer (e.g., height, weight, eye color, hair color, SSN, etc.).

The information included within the interface 300B can be used to perform various operations by the administrator 104. For example, the information can be used to perform identity verification checks with information obtained from other external systems that are not associated with the IMS 130. In some implementations, the identity verification checks may be automatically performed periodically when the record management module 132 detects an addition and/or revision to credential data within the database record. In another example, the information can also be used to search for customers that have particular citations, violations, or sanctions, as well as identifying duplicate database records that may be merged to preserve data integrity of the credential data.

FIG. 4 illustrates an example of an interface 400 provided by the rule engine 135 for configuring and customizing individual software modules of the digital identification management system. The interface 400 may be used to add new rules to the rule repository 144, or adjust the configuration for existing rules within the rule repository 144. The interface 400 generally includes a ribbon bar that provides a set of editor functions to modify a selected rule. In addition, the interface 400 also includes a navigation pane that allows the administrator 104 to create a hierarchy of rules that are categorized by user interface elements, applications, and specific business workflow calculations. In the example depicted, the directory for “VEHICLE” includes three rules “GetFees,” “GetRegistrationFees,” and “GetTitleFees.” These rules may be used to calculate fees associated with a vehicle registration transaction performed by the customer 102 on the customer portal 131. For example, when the customer 102 attempts to add a new title registration for a vehicle, the rules indicate may be used by the rule engine 135 to automatically calculate values for the applicable fees based on the user input provided the customer 105.

The administrator 104 may use the workspace area of the interface 400 to define a new rule and/or adjust the specification of an existing rule that is included within the rule repository 144. For example, the administrator 104 specify conditional logic that designates a set of system actions to be performed if one or more conditions associated with a rule are satisfied. In the example depicted, the workflow allows the administrator 104 to specify a particular action to be performed if the status of a vehicle is determined to be “active.”

Although FIG. 4 illustrates an interface that may be used to configure business logic related to user interface elements that are provided for output to customers, in other implementations, individual rules may be configured to adjust the software architecture of the IMS 130 as described above. For example, rules within the rule repository 144 may of different scopes such that some rules are configured to adjust the operation of specific software components or specific business workflows associated with the specific software components, whereas other rules may be configured to broader applicability to adjust the way in which data is exchanged between, for example, the IMS 130 and legacy system 120.

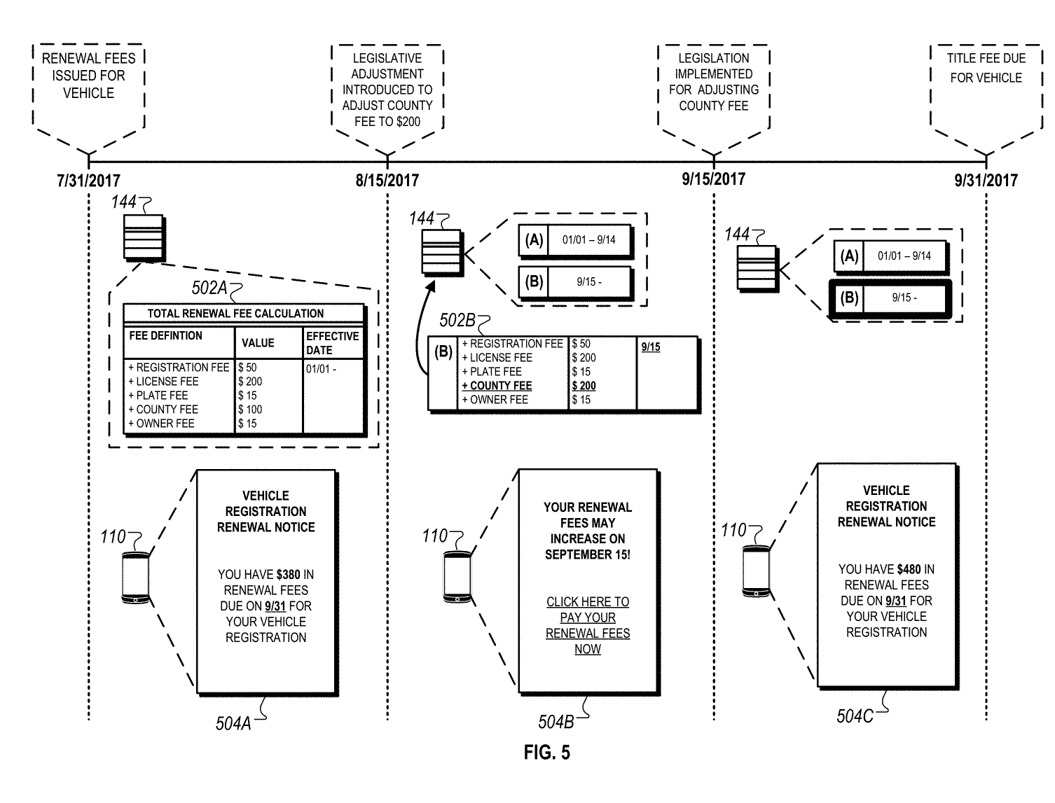

FIG. 5 is a schematic diagram that illustrates an example of a process for adjusting the management of credential data based on changes to legislative frameworks relating to a credential issued to a customer. In the example depicted, the IMS 130 generally applies the rule engine 135 to dynamically adjust the calculation of a data parameter, e.g., vehicle registration fee, that is associated with a credential issued to a user, e.g., a vehicle identification number. In this example, a jurisdiction, such as the municipality, has introduced legislation that adjusts, for example, the county fee that a motor vehicle agency charges customers when they renew a vehicle registration.

In the timeline shown in the example depicted in FIG. 5, a vehicle registration renewal notice 504A is initially provided to the customer device 110 on Jul. 31, 2017. The notification 504A includes a total renewal fee, which is calculated by the IMS 130 using a configuration rule 502A. In this example, the configuration rule 502A, which can be defined by an administrator associated with the state motor vehicle agency, as discussed above with respect to FIG. 4, includes fields “Fee Definition,” “Value,” and “Effective Date.” The “Fee Definition” field lists a set of individual fees that are associated with vehicle registration renewal, the “Value” field specifies the dollar amount corresponding to each individual fee, and the “Effective Date” provides a start date when the configuration rule 502A began being applied by the IMS 130. As shown, the configuration rule 502A can be stored within the rule repository 144, which is discussed above with respect to FIGS. 1A and 4.

In the example depicted in FIG. 5, legislation that adjusts the county fee for vehicle registration renewal is introduced in the jurisdiction on Aug. 15, 2017. In this example, the legislation specifies a one-month time period before the legislation goes into effort, e.g., legislation is scheduled into effect on Sep. 15, 2017. A new configuration rule 502B, which is compliant with the newly introduced legislation, is then inserted into the rule repository 144. The configuration rule 502B can be included in the rule repository 144 based on a user input provided by the administrator on the interface 400 as discussed above with respect to FIG. 4.

In some implementations, the configuration rule 502B can be automatically generated by the IMS 130, e.g., without human intervention, based on receiving verification data from one or more external computer systems such as a computer system associated with a government legislative office. In such implementations, the verification data can indicate the legislative adjustment to the county fee for vehicle registration, which then causes the rule engine 135 to automatically generate an alternative rule configuration to the existing rule configuration stored in the rule repository 144.

As shown in the example depicted in FIG. 5, the configuration rule 502B specifies an adjusted value for county fee that is in compliance with the new legislation. However, because the newly introduced legislation becomes effective on Sep. 15, 2017, customers that renew their vehicle registrations prior to Sep. 15, 2017 are still charged a $100 fee (instead of the $200 fee as specified by the newly introduced legislation). To ensure that payments for renewal fees before Sep. 15, 2017 are correctly processed, the rule repository 144 includes both rule configurations 502A and 502B for total renewal fee calculation. The IMS 130 applies the rule configuration 502A to calculate total renewal fees due before Sep. 15, 2017, but applies the rule configuration 502B to calculate total renewal fees due after Sep. 15, 2017. The IMS 130 therefore provides a notification 504B to the customer device 101 informing the customer that his/her total renewal fees may increase if he/she does not submit payment before Sep. 15, 2017.

Still referring to the example depicted in FIG. 5, once the legislation is entered into effect on Sep. 15, 2017, the rule engine 135 deactivates the rule configuration 502A and instead applies only the rule configuration 502B in calculating total renewal fees that are due. Any renewal fees due after this date are therefore calculated using the rule configuration 502B. In this regard, the IMS 130 helps customers remain legislatively-compliant by dynamically adjusting calculation of data parameters that are associated with issued credentials.

Although the example depicted in FIG. 5 relates to using rule configurations to adjust calculation of data parameters in response to changes in legislation, in some implementations, the rule engine 135 can be configured to use similar techniques to implement other types of legislative changes. For example, the rule engine 135 can be configured to generate multiple rule configurations that adjust privileges granted with an issued credential if legislation that is introduced adds or removes certain privileges associated with the issued credential. In another example, if legislation adjusts the management of privileges, the rule engine 135 can configure rules that adjust data schema or models that are used to manage data associated with privileges. To illustrate, if newly introduced legislation increase the requirements for the issuing authority to verify credential data when processing a renewal application for an issued credential, then the rule engine 135 can be configured to generate an application rule that increases the number of data fields within the identification repository 142 that are verified in relation to a renewal process.

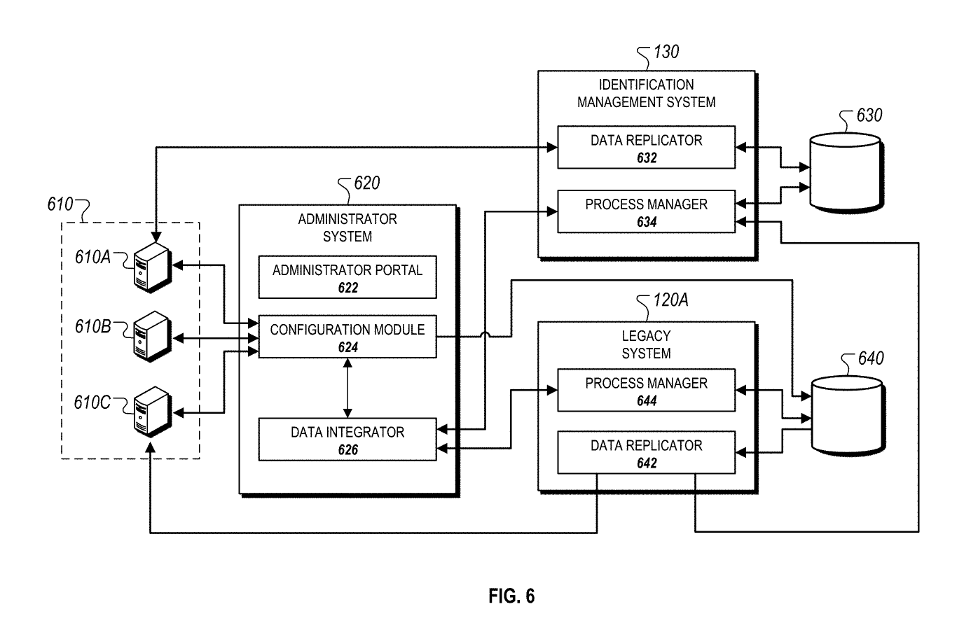

FIG. 6 is a schematic diagram that illustrates an example of an architecture 600 that enables bi-directional data replication and synchronization between two identification systems of an issuing authority. The architecture 600 generally includes a high-availability cluster 610, which further includes cluster servers 610A, 6106, and 610C, an administrator system 610, the IMS 130, and a legacy system 120A.

The administrator system 610 further includes an administrator portal 622, a configuration module 624, and a data integrator 626. The IMS 130 and legacy system 120A each include a data replicator and a data processor, e.g., the data replicators 632 and 642, respectively, and the data processors 634 and 644, respectively. Credential data associated with the IMS 130 is stored in the repository 130, which in some instances, corresponds to the identification repository 142 discussed above with respect to FIG. 1A. Credential data associated with the legacy system 120A is stored in a repository 640.

In the example depicted in FIG. 6, the IMS 130 can represent, for instance, a modernized identification management system that supplements and/or replaces the data processes of the legacy system 120A that are performed in relation to credential issuance, credential and/or privilege management, and/or credential data access. To illustrate, an issuing authority may use the IMS 130 to execute data operations relating to the issuance and management of digital identifications, which is based on, and/or has dependencies to, data managed on the legacy system 120A. For example, issuance process for a digital identification may require the verification of credential data that is stored at the legacy system 120A.

Credential data managed by the IMS 130 is stored in a repository 620, which, in some instances, can correspond to the identification repository 142. Credential data managed by the legacy system 120A, instead, is stored in a repository 630. However, because the IMS 130 and the legacy system 120A, in this example, are distinct and disparate systems, e.g., systems that use different data protocols, credential data within the repository 620 can be stored in a different format and according to different data schema compared to the credential data stored within the repository 630. The architecture 600 can therefore be used to reduce the likelihood of data errors taking place when processing operations are performed by the system 100A that involve accessing and/or retrieving data from both of the repositories 620 and 630.

Generally, an administrator, such as an employee of the issuing authority or an employee of a service provider authorized to access and manage credential data of the issuing authority, can use the administrator system 610 to manage data operations relating to bi-directional data replication and synchronization for data stored on the repositories 630 and 640. The administrator can access an administrator portal 622, which includes a user interface through which the administrator can provide user input to view, configure, and manage bi-direction data replication and synchronization operations. For example, the administrator can view recent data operations performed on the IMS 130 and/or the legacy system 120A, access stored data on the repositories 630 and 640 that has been recently changed, and/or initiate data operations.

Referring briefly to the components involved in a data replication operation, the process managers 624 and 634 identify and regulate data processes that are executed by the IMS 130 and the legacy system 130A, respectively. Such data processes include normal data processes, e.g., routine data maintenance operations, and specialized data processes, e.g., data processes that may require replication and/or synchronization. As an example, a specialized data process may be a value adjustment to a database field within a database record stored in the repository 620, which, if not replicated in a corresponding database record stored in the repository 630, is likely to result in an error when calculating a data parameter using values retrieved from corresponding database fields within each of the repositories 620 and 630.

Data replicators 622 and 632 access and retrieve data stored in the repositories 620 and 630, respectively, based on the process managers 624 and 634 determining that a specialized data process is likely to be performed by either the IMS 130 or the legacy system 120A. For example, once the processor manager 624 determines that the IMS 130 is likely to perform a specialized data process, the data replicator 622 accesses and retrieves data associated with the specialized data process and transmits the retrieved data to the cluster server 610.

The high-availability cluster 610 provides a data virtualization layer on a secure network to enable the exchange of credential data between the IMS 130 and the legacy system 130A. For example, the high-availability cluster 610 includes the cluster server 610A, which stores virtualization data associated with data stored in the repository 630, and the cluster server 610C, which stores virtualization data stored with the data stored in the repository 640. The high-availability cluster 610 also includes the cluster server 610B, which stores configuration data for performing various processing operations relating to data replication, data synchronization, data migration, data integration, etc.

In some implementations, the high-availability cluster 610 may be implemented on a secure network that is managed by an entity that is distinct from the issuing authority and/or the data service provider that manages the IMS 130. As an example, the high-availability cluster 610 can be implemented on a secure network managed by the AAMVA, which provides access to commercial driver license holder data that is stored in the repositories 630 and 640.

The high-availability cluster 610 provides the administrator system 610 with access to data retrieved from the repositories 630 and 640, e.g., data associated with specialized processes that is to be replicated between the IMS 130 and the legacy system 120A. In some instances, the cluster server 610B aggregates the data retrieved by the cluster servers 610A and 6106 and provide aggregated data to the configuration module 624. Alternatively, in other instances, the data retrieved on the high-availability cluster 610 can be transmitted to the configuration module 624 and aggregated locally on the administrator system 620 by the configuration module 624.

The configuration module 624 includes a data management module (not shown) and a mapping module (not shown), which are configured to determine a data update instruction to implement a data replication operation. In the example depicted in FIG. 6, the configuration operation 624 determines a data update instruction to replicate data obtained from the repository 630 within the repository 640. In this example, the configuration module 624 only replicates data within the repository 640 since the IMS 130 represents a modernized system that is presumed to include the most up-to-date credential data for credentials issued and/or being issued by the issuing authority. In some other implementations, the configuration module 624 may be capable of generating data update instructions to update the repository 630 and/or the repository 640.

The architecture 600 can configured to implement parallel operations such that the existing configuration with the legacy system 120A is sustained simultaneously with the introduction of the IMS 130. For example, the architecture 600 can implement data deployment procedure that ensures minimal impact to the ongoing operations of the legacy system 120A may be used during the introduction of the IMS 130. The introduction may be performed incrementally to enhance quality assurance through testing during the transition between the legacy system 120A and the IMS 130.

In some implementations, the architecture 600 may be dynamically associated and de-associated with the system 100 to minimize adverse impacts to credential data stored within the identification repository 142. The architecture 600 can be used to manage network addressing and security protocols over a secure network, e.g., the high-availability cluster 610, to operate as a traffic router between the legacy system 120A, the IMS 130, and servers that provides access to credential data over the secure network. The architecture 600 also replicate inbound traffic from the secure network and merge outbound messaging traffic to the secure network to enable parallel operation of the legacy system 120A and the IMS 130.

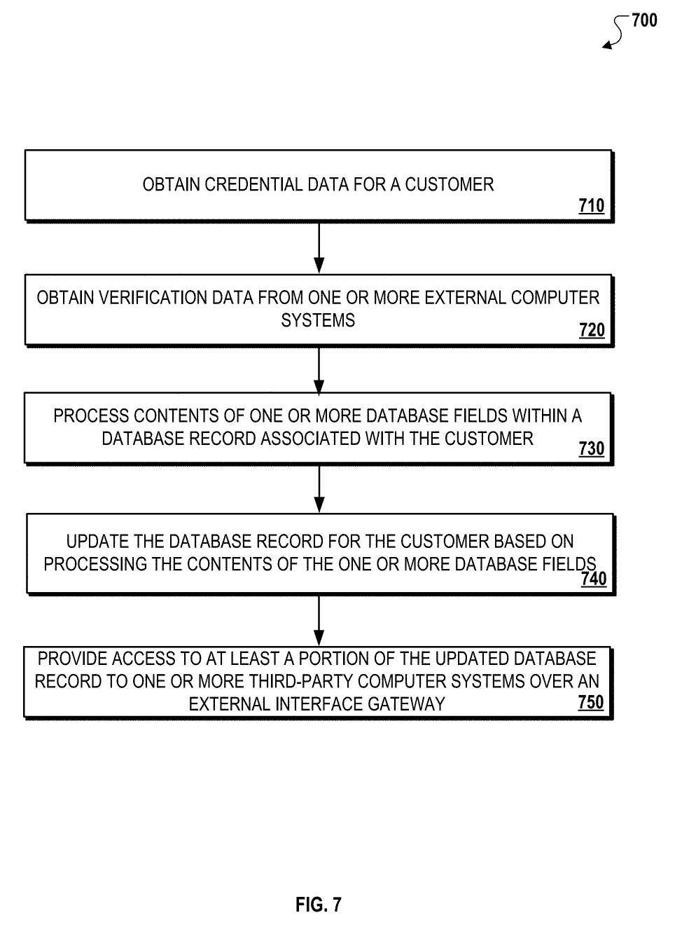

FIG. 7 is a flowchart that illustrates an example of a process 700 for managing credential data for a customer using an integrated architecture. Briefly, the process 600 can include the operations of obtaining credential data for a customer (710), obtaining verification data from one or more external computer systems (720), processing contents of one or more database fields within a database record associated with the customer (730), updating the database record for the customer based on processing the contents of the one or more database fields (740), and providing access to at least a portion of the updated database record to one or more third-party computer systems over an external interface gateway (750).

The process 700 is described below in reference to the system 100 although other systems can be capable of performing the operations specified by the process 600. In one example, the process 700 is performed on a server system that includes the IMS 130. The server system can be managed by an issuing authority that issues a credential, e.g., a physical credential or a digital credential, to the customer 102. In another example, the process 700 is performed on a server system of an entity that is distinct from the issuing authority but is authorized to manage credential data of customers that have been issued the credential, e.g., a data service provider that contracts with the issuing authority.

In more detail, the process 700 includes the operation of obtaining credential data for a customer (710). For example, the IMS 130 can obtain credential data indicating a credential issued to the customer 102 by the issuing authority. As discussed above, the credential can be a physical credential that is physically issued to the customer 102, e.g., a driver's license, or a digital credential that is electronically issued to the customer 102, e.g., a digital identification card. The issuing authority can be a governmental agency that regulates privileges associated with a certain type of customer activity, e.g., a state motor vehicle agency that regulates licensure of driving-related activities, or alternatively, a non-governmental agency that provides customers with credentials that provide certain privileges, e.g., a corporation that issues new employees with identification cards for access privileges.

The credential data obtained by the IMS 130 can include various types of data or information associated with an issued credential. In some instances, the credential data includes user-submitted changes to credential data provided by the customer 102, e.g., a change to a customer name displayed on a physical credential. In other instances, the credential data includes changes to an issued credential provided by the administrator 104, e.g., issuance of a new credential to replace an expired credential.

The credential data can be used by the IMS 130 to determine database records stored within the identification repository 142 that are associated with the customer 102 and/or the credential issued to the customer 102. As an example, credential data including a driver license number for the customer 102 can be used by the IMS 130 to identify stored database records relating to traffic infractions of the customer 102, vehicle registrations for vehicles used by the customer 102, among others.

The process 700 includes the operation of obtaining verification data from one or more external computer systems (720). For example, the IMS 130 can obtain verification data from one or more external computer systems 120 that are distinct from the IMS 130. The verification data can include any type of data or information that relates to a credential issued to the customer 102. As an example, the verification data can specify a known social security number of the customer 102 that is used by the IMS 103 to verify the identity of the customer 102 when he/she requests to submit a change to credential data associated with an issued credential. As another example, the verification data can include credential data managed by an external data service provider that is authorized to manage data related to the issued credential. In this example, the verification data can include title and/or information for vehicles that are registered to the customer 102 and associated with the driver license issued to the customer 102.

As discussed above, the external computer systems 120 can run CRM software 122 and/or COTS software 124 that manage data and/or information associated with the credential associated with the credential issued to the customer 102 by the issuing authority. In some implementations, the external computer systems 120 are managed by data service providers that are independent from the issuing authority but are authorized to access and manage information relating to database records stored in the identification repository 142. For example, the external computer systems 120 can be managed by a vehicle title registration company that stores vehicle insurance and/or maintenance data for vehicles that are registered within the identification repository 142. In this example, the issuing authority can be a state motor vehicle agency that issues driver licenses to customers of the vehicles registered within the identification repository 142.

Alternatively, in other implementations, the external computer systems 120 are managed by the issuing authority that issues credentials to customers such as the customer 102. For example, the external computer systems 120 can manage and store verification customer data that is used to verify information provided by the customer 102 during, for example, a credential enrollment process or during a process to replace an existing credential with a newly issued credential, e.g., replacing an existing credential due to a change to the customer's demographic information, issuing a new credential due to the prior credential becoming expired.

In some instances, the external computer systems 120 can be legacy systems of the issuing authority that store data relating to pre-existing credentials, or other types of historical data. In such instances, the IMS 130 can be capable of accessing and/or maintaining data stored within the computer systems 120 to ensure that the database records stored within the identification repository 142 reflect up-to-date customer and/or credential information. As discussed above with respect to FIG. 6, the IMS 130 may perform bi-direction data synchronization and/or replication techniques to periodically update data stored on the identification repository 142 and data stored on the external computer systems 120. For example, the IMS 130 may detect changes to data stored in the identification repository 142 and generate instructions that cause the external computer systems 120 to update corresponding data stored at the external computer systems 120 to avoid storing outdated data. The IMS 130 may also detect changes to data stored at the external computer systems 120 and generate instructions that adjust corresponding data stored in the identification repository 142.

The process 700 includes the operation of processing contents of one or more database fields within a database record associated with the customer (730). For example, the IMS 130 can process contents of one or more database fields within a database record stored in the identification repository 142. As discussed above, the IMS 130 can perform different data processing operations relating to, for example, credential issuance to the customer 102, management of privileges granted by the issued credential, management of access to data stored in the identification repository, verification of credential data of the customer 102 and/or the issued credential, among others.

For instance, the IMS 130 may verify user-specified values for one or more database fields within credential data obtained from the customer device 110, e.g., demographic information provided by the customer 102. The IMS 102 may then identify one or more corresponding database fields within a database record for the customer 102 within the identification repository 142. The IMS 102 then obtains verification data that includes verified values for the one or more database fields from the external computer systems 120, e.g., verified demographic information for the customer 102 associated with the customer's bank account. In this example, if the user-specified values for the one or more database fields within the credential data matches the verified values for the one or more database fields within the verification data, then the IMS 130 determines that the credential data is valid and in response, update the values for the one or more database fields within the database record stored in the identification repository 142.

In another instance, the IMS 130 may use the verification data obtained from the external computer systems 120 to identify multiple database records within the identification repository 142 that are associated with the same customer 102, e.g., a database record for a driver license of the customer 102 and a database record for a vehicle registration for a vehicle previously owned by the customer 102. Alternatively, the IMS 130 may identify multiple database records that are associated with the same issued credential, e.g. a database record specifying traffic infractions for a driver license number and another database record identifying prior driver license cards issued to the driver license number. In these examples, the IMS 130 can use verified data for the customer 102 and/or the issued credential to associate the multiple database records stored within the identification repository 142 that may have otherwise been unable to be identified as being associated. Once multiple database records have been identified to be associated, the IMS 130 may generate a mapping that identifies the associated database records. For example, the IMS 130 may generate a search index, a longitudinal mapping, or some other type of database association, that is then stored within each of the associated database records. In such examples, the database associations can be used by the IMS 130 more quickly and/or easily retrieve identify credential data in associated database records when performing a database operation involving the associated database records, e.g., accessing contents of multiple database records to compute a database parameter related to the issued credential.

The process 700 includes the operation of updating the database record for the customer based on processing the contents of the one or more database fields (740). For example, the IMS 130 can update a database record for the customer 102 based on processing the contents of the one or more database fields. As discussed above in step 730, the IMS 130 may perform different processing operations that involve obtained credential data and the verification data obtained from the external computer systems 120. For instances where the processing operation involves verifying the contents of the identification data, the IMS 130 may update corresponding database fields within a database record stored in the identification repository 142 to include verified identification data. In other instances where the processing operation involves associating multiple database records within the identification repository 142, the IMS 130 may update the contents of the database record to include, for example, a mapping that identifies the associated database records.

The process 700 includes the operation of providing access to at least a portion of the updated database record to one or more third-party computer systems over an external interface gateway (750). For example, the IMS 130 may provide access to at least a portion of the database record updated in step 740 and stored in the identification repository 142 over the EIG 150 to one or more of the external devices depicted in FIG. 1A, e.g., the government agency system 152, the service provider system 154, the customer device 110. As discussed above, the external devices can be managed by, used by, or otherwise associated with, entities that are distinct and independent from the issuing authority such as a separate government agency, a third-party data provider, and/or the customer 102. In this regard, the EIG 150 enables the IMS 130 provide controlled access to data stored within the identification repository 142.

In some implementations, the IMS 150 may control the level of access provided to different external devices over the EIG 150. For example, in such implementations, the IMS 150 may manage an access control list (ACL) that specifies a set of access privileges for each of the external devices connected to the IMS 150 over the EIG 150. The access privileges can specify, for example, data fields within database records that an external device may be provided with access, data fields within database records that are restricted from access by the external device, and/or database fields that require redaction prior to granting access in order to protect personally identifiable information (PII) of customers whose credential data is stored within the identification repository 142. Different external devices may be provided with different levels of access based on the type of access authorization specified by the issuing authority. For example, an external device managed by a government entity, such as the government agency system 152, may be provided with a greater level of access to the identification repository 142 compared to an external device of the customer 102, such as the customer device 110.

In some implementations, the IMS 130 is managed by an entity that is distinct from each of the issuing authority that issues the credential for the customer 102, the entities that manage the external computing systems 120, and/or the entities that manage the external devices connected to the IMS 130 over the EIG 150. For example, the entity that manages the IMS 130 may be a data service provider that contracts with the issuing authority to manage, store, maintain data operations relating to credential data stored within the identification repository 142. In this example, the identification repository 142 can include credential data generated by the issuing authority, and the IMS 130 can be used by the data service provider to support, for example, credential issuance procedures by the issuing authority and/or credential management operations relating to issued credentials.

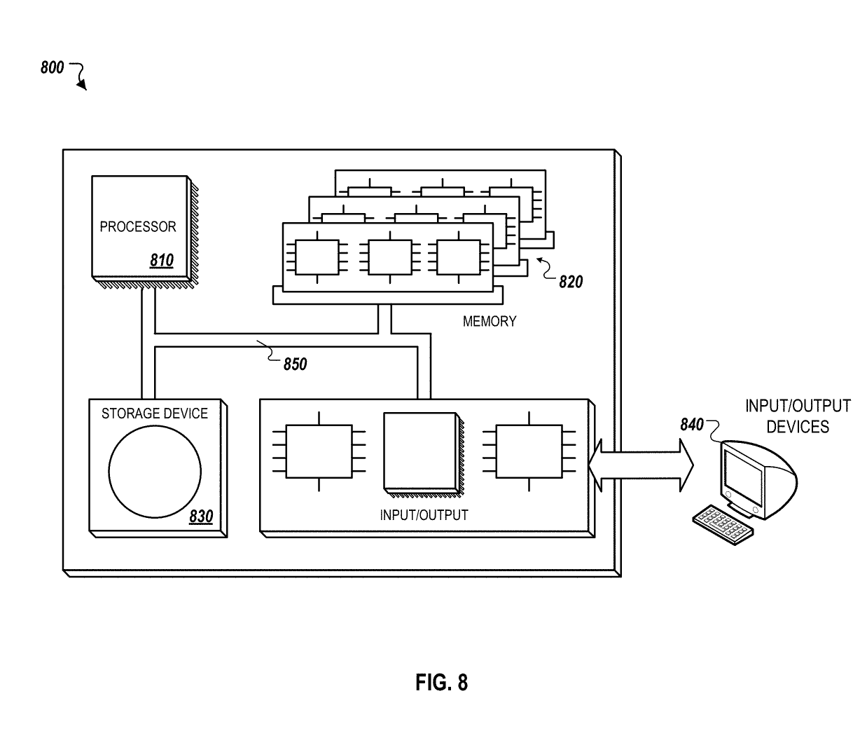

FIG. 8 illustrates a schematic diagram of a computer system 800 that may be applied to any of the computer-implemented methods and other techniques described herein. The system 800 can be used to carry out the operations described in association with any of the computer-implemented methods described previously, according to some implementations. In some implementations, computing systems and devices and the functional operations described in this document can be implemented in digital electronic circuitry, in tangibly-embodied computer software or firmware, in computer hardware, including the structures disclosed in this document (e.g., system 800) and their structural equivalents, or in combinations of one or more of them. The system 800 is intended to include various forms of digital computers, such as laptops, desktops, workstations, personal digital assistants, servers, blade servers, mainframes, and other appropriate computers, including vehicles installed on base units or pod units of modular vehicles. The system 800 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 800 includes a processor 810, a memory 820, a storage device 830, and an input/output device 840. Each of the components 810, 820, 830, and 840 are interconnected using a system bus 840. The processor 810 is capable of processing instructions for execution within the system 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this document contains many specific implementation details, these should not be construed as limitations on the scope of any inventions or of what may be claimed, but rather as descriptions of features specific to particular implementations of particular inventions. Certain features that are described in this document in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining, by a server system, credential data for a customer, the credential data indicating a credential issued to the customer by an issuing authority;
obtaining, by the server system and from one or more external computer systems that are distinct from the server system, verification data associated with the credential issued to the customer;
processing, by the server system and based at least on the verification data obtained from the one or more external computer systems, contents of one or more database fields within a database record associated with the customer;
updating, by the server system, the database record for the customer based on processing the contents of one or more database fields; and
providing, by the server system and to one or more third-party computer systems over an external interface gateway, access to at least a portion of the updated database record.

2. The method of claim 1, wherein:
the obtained credential data for the customer comprises user-specified values for the one or more database fields; and
processing the contents of one or more database fields comprises:
identifying one or more verified values of the one or more database fields within the verification data obtained from the one or more external computer systems; and
determining that the user-specified values for the one or more database fields are valid based on comparing the user-specified values for the one or more database fields to the one or more verified values of the one or more database fields within the verification data.

3. The method of claim 1, wherein:
the database record is stored in an identification repository, the identification repository comprising database records associated with different customers;
processing the contents of one or more database fields comprises:
determining, based on the verification data obtained from the one or more external computer systems, that a particular database record from among the database records within the identification repository is associated with the customer; and
generating a mapping that associates one or more fields of the database record and one or more corresponding fields of the particular database that is determined to be associated with customer; and
updating the database record for the customer comprising storing the generated mapping within the database record.

4. The method of claim 1, wherein the server system is managed by an entity that is distinct from each of (i) the issuing authority, (ii) entities that manage the one or more external computer systems, and (ii) entities that manage the one or more third-party computer systems.

5. The method of claim 1, wherein the one or more external computer systems comprises a legacy computer system of the issuing authority; and
the method further comprises:
identifying, by the server system, a change to a legacy database field within a legacy database record that is (i) associated with the customer, and (ii) stored at the legacy computer system; and
generating, by the server system and based on the identified change to the legacy database field within the legacy database record, a first instruction to update a database field within the database record, the database field within the database record corresponding to the legacy database field within the legacy database record.

6. The method of claim 5, further comprising:
identifying, by the server system, a change to a second database field within the database record; and
generating, by the server system and based on the identified change to the second database field within the database record, a second instruction that, when received by the legacy computer system, causes the legacy computer system to update a second legacy database field within the legacy database record, the second database field within the database record corresponding to the second legacy database field within the second legacy database record.

7. The method of claim 1, wherein the one or more external computer systems comprises a computer system managed by an entity that is distinct from the issuing authority.

8. The method of claim 1, wherein:
the one or more external computer systems comprises (i) a first computer system running COTS software, and (ii) a second computer system running CRM software; and
the server system comprises a communication module that exchanges data transmissions with each of the COTS software and the CRM software.

9. The method of claim 1, wherein the credential issued to the customer is a physical credential.

10. The method of claim 1, wherein the credential issued to the customer is a digital credential.

11. The method of claim 1, further comprising:
obtaining, by the server system and from a rule repository, data indicating multiple configuration rules for computing a data parameter associated with the credential issued to the customer;
selecting, by the server system, a configuration rule from among the multiple configuration rules based on the verification data obtained from the one or more external computer systems; and
computing, by the server system, the data parameter associated with the credential issued to the customer based on the selected configuration rule.

12. The method of claim 11, wherein:
the multiple configuration rules comprise (i) a first configuration rule specifying a first computation of the data parameter based on a first definition, and (ii) a second configuration rule specifying a second computation of the data parameter based on a second definition, the first definition being different than the second definition; and
the verification data obtained from the one or more external computer systems indicates that a jurisdiction associated with the credential will introduce legislation that adjusts the first definition to the second definition at a specified date; and
the method further comprises:
before the specified date, computing, by the server system, the data parameter associated with the customer based on the first configuration rule; and
after the specified date, computing, by the server system, the data parameter associated with the customer based on the second configuration rule.

13. A system comprising:
one or more computers; and
one or more storage devices storing instructions that, when executed by the one or more computers, cause the one or more computers to perform operations comprising:
obtaining, by a server system, credential data for a customer, the credential data indicating a credential issued to the customer by an issuing authority;
obtaining, by the server system and from one or more external computer systems that are distinct from the server system, verification data associated with the credential issued to the customer;
processing, by the server system and based at least on the verification data obtained from the one or more external computer systems, contents of one or more database fields within a database record associated with the customer;
updating, by the server system, the database record for the customer based on processing the contents of one or more database fields; and
providing, by the server system and to one or more third-party computer systems over an external interface gateway, access to at least a portion of the updated database record.

14. The system of claim 13, wherein:
the obtained credential data for the customer comprises user-specified values for the one or more database fields; and
processing the contents of one or more database fields comprises:
identifying one or more verified values of the one or more database fields within the verification data obtained from the one or more external computer systems; and
determining that the user-specified values for the one or more database fields are valid based on comparing the user-specified values for the one or more database fields to the one or more verified values of the one or more database fields within the verification data.

15. The system of claim 13, wherein:
the database record is stored in an identification repository, the identification repository comprising database records associated with different customers;
processing the contents of one or more database fields comprises:
determining, based on the verification data obtained from the one or more external computer systems, that a particular database record from among the database records within the identification repository is associated with the customer; and
generating a mapping that associates one or more fields of the database record and one or more corresponding fields of the particular database that is determined to be associated with customer; and
updating the database record for the customer comprising storing the generated mapping within the database record.

16. A non-transitory computer-readable storage device encoded with computer program instructions that, when executed by one or more computers, cause the one or more computers to perform operations comprising:
obtaining, by a server system, credential data for a customer, the credential data indicating a credential issued to the customer by an issuing authority;
obtaining, by the server system and from one or more external computer systems that are distinct from the server system, verification data associated with the credential issued to the customer;
processing, by the server system and based at least on the verification data obtained from the one or more external computer systems, contents of one or more database fields within a database record associated with the customer;
updating, by the server system, the database record for the customer based on processing the contents of one or more database fields; and
providing, by the server system and to one or more third-party computer systems over an external interface gateway, access to at least a portion of the updated database record.

17. The device of claim 16, wherein:
the obtained credential data for the customer comprises user-specified values for the one or more database fields; and
processing the contents of one or more database fields comprises:
identifying one or more verified values of the one or more database fields within the verification data obtained from the one or more external computer systems; and
determining that the user-specified values for the one or more database fields are valid based on comparing the user-specified values for the one or more database fields to the one or more verified values of the one or more database fields within the verification data.

18. The device of claim 16, wherein:
the database record is stored in an identification repository, the identification repository comprising database records associated with different customers;
processing the contents of one or more database fields comprises:
determining, based on the verification data obtained from the one or more external computer systems, that a particular database record from among the database records within the identification repository is associated with the customer; and
generating a mapping that associates one or more fields of the database record and one or more corresponding fields of the particular database that is determined to be associated with customer; and
updating the database record for the customer comprising storing the generated mapping within the database record.

19. The device of claim 16, wherein the server system is managed by an entity that is distinct from each of (i) the issuing authority, (ii) entities that manage the one or more external computer systems, and (ii) entities that manage the one or more third-party computer systems.

20. The device of claim 16, wherein:
the one or more external computer systems comprises a legacy computer system of the issuing authority; and
the operations further comprise:
identifying, by the server system, a change to a legacy database field within a legacy database record that is (i) associated with the customer, and (ii) stored at the legacy computer system; and
generating, by the server system and based on the identified change to the legacy database field within the legacy database record, a first instruction to update a database field within the database record, the database field within the database record corresponding to the legacy database field within the legacy database record.
